(19) United States
(12) Patent Application Publication
(10) Pub. No.: US 2006/0164682 A1
(43) Pub. Date: Jul. 27, 2006

(54) System and method of improving the legibility and applicability of document pictures using form based image enhancement

(75) Inventor: Zvi Haim Lev, Tel Aviv (IL)

Correspondence Address: SUGHRUE MION, PLLC, 2100 PENNSYLVANIA AVENUE, N.W., SUITE 800, WASHINGTON, DC, 20037, US

(73) Assignee: DSPV, LTD., Tel Aviv (IL)

(21) Appl. No.: 11/337,492

(22) Filed: Jan. 24, 2006

Related U.S. Application Data
(60) Provisional application No. 60/646,511, filed on Jan. 25, 2005.

(51) Int. Cl. G06F 3/12

(52) U.S. Cl. 358/1.15; 358/540

(57) ABSTRACT

A system and method for imaging a document, and using a reference document to place pieces of the document in their correct relative position and resize such pieces in order to generate a single unified image, including the electronic capturing a document with one or multiple images using an imaging device, the performing of pre-processing of said images to optimize the results of subsequent image recognition, enhancement, and decoding, the comparing of said images against a database of reference documents to determine the most closely fitting reference document, and the applying of knowledge from said closely fitting reference document to adjust geometrically the orientation, shape, and size of said electronically captured images so that said images correspond as closely as possibly to said reference document.

### CROSS-REFERENCE TO RELATED APPLICATIONS

This application claims the benefit of U.S. Provisional Application Ser. No. 60/646,511, filed on Jan. 25, 2005, entitled, “System and method of improving the legibility and applicability of document pictures using form based image enhancement”, which is incorporated herein by reference in its entirety.

### BACKGROUND OF THE NON-LIMITING EMBODIMENTS OF THE INVENTION

1. Field of the Exemplary Embodiments of the Invention

Exemplary embodiments of the present invention relates generally to the field of imaging, storage and transmission of paper documents, such as predefined forms. Furthermore, these exemplary embodiment s of the invention is for a system that utilizes low quality ubiquitous digital imaging devices for the capture of images/video clips of documents. After the capture of these images/video clips, algorithms identify the form and page in these documents, position of the text in these images/video clips of these documents, and perform special processing to improve the legibility and utility of these documents for the end-user of the system described in these exemplary embodiments of the invention.

2. Definitions

Throughout this document, the following definitions apply. These definitions are provided to merely define the terms used in the related art techniques and to describe non-limiting, exemplary embodiments of the present invention. It will be appreciated that the following definitions are not limitative of any claims in any way.

“Computational facility” means any computer, combination of computers, or other equipment performing computations, that can process the information sent by the imaging device. Prime examples would be the local processor in the imaging device, a remote server, or a combination of the local processor and the remote server.

“Displayed” or “printed”, when used in conjunction with an imaged document, is used extensively to mean that the document to be imaged is captured on a physical substance (as by, for example, the impression of ink on a paper or a paper-like substance, or by embossing on plastic or metal), or is captured on a display device (such as LED displays, LCD displays, CRTs, plasma displays, ATM displays, meter reading equipment or cell phone displays).

“Form” means any document (displayed or printed) where certain designated areas in this document are to be filled by handwriting or printed data. Some examples of forms are: a typical printed information form where the user fills in personal details, a multiple choice exam form, a shopping web-page where the user has to fill in details, and a bank check.

“Image” means any image or multiplicity of images of a specific object, including, for example, a digital picture, a video clip, or a series of images. Used alone without a modifier or further explanation, “Image” includes both “still images” and “video clips”, defined further below.

“Imaging device” means any equipment for digital image capture and sending, including, for example, a PC with a webcam, a digital camera, a cellular phone with a camera, a videophone, or a camera equipped PDA.

“Still image” is one or a multiplicity of images of a specific object, in which each image is viewed and interpreted in itself, not part of a moving or continuous view.

“Video clip” is a multiplicity of images in a timed sequence of a specific object viewed together to create the illusion of motion or continuous activity.

3. Description of the Related Art

There are numerous existing methods and systems for the imaging and digitization of scanned documents. These imaging and digitization systems include, among others:

1. Special purpose flatbed scanners where the document is placed on a fixed planar imaging system.

2. Handheld scanners where the document of interest is placed on a flat surface and the handheld scanners are manually moved while in close contact with this document.

3. High-resolution cameras on fixtures. These fixtures provide a fixed imaging geometry of the imaging being fixed. Furthermore, special lighting may be provided to enable high quality uniform contrast and illumination conditions.

4. Facsimile machines and other special purpose scanners where the document of interest is moved mechanically through the scanning element of the scanner.

These existing systems provide a cost effective, reliable solution to the problem of scanning documents, but these systems require special hardware that is costly, and additional hardware that is both costly and not very portable (that is, hardware which must be carried by the user). Furthermore, these existing systems are suited mainly for the imaging of non-glossy planar paper documents. Thus, they cannot serve for the imaging of glossy paper, of plastic documents, or of other displays that are not non-glossy paper. They are also not suited for the imaging of non planar objects.

The popularity of mobile imaging devices such as camera phones has led to the development of solutions that attempt to perform similar document scanning using such present-day camera phones as the imaging device. The raw images of documents taken by a camera phone are typically not useful for sending via fax, for archiving, for reading, or for other similar uses, due primarily to the following effects:

1. As a result of limited imaging device resolution, physical distance limitations, and imaging angles, the capture of a readable image of a full one page document in a single photo is very difficult. With some imaging devices, the user may be forced to capture several separate still images of different parts of the full document. With such devices, the parts of the full document must be assembled in order to provide the full coherent image of the document. (It may be noted, however, with other imaging devices, notably some scanners, fax machines, and high resolution cameras for taking fixed images, multiple images are typically not required, but this equipment is expensive, often not easily portable, and generally incapable of dealing with quality issues where the document to be captured is not of high quality, or is not on glossy paper, or suffers other optical defects, as discussed above.) The resolution limitation of mobile devices is a result of both the imaging equipment itself, and of the network and protocol limitations. For example, a 3G mobile phone can have a multi-megapixel camera, yet in a video call the images in the captured video clip are limited to a resolution of 176 by 144 pixels due to the video transmission protocol.

2. Since there is no fixed imaging angle common to all still images of the parts of the full document, the multiple still images suffer from variable skewing, scaling, rotation and other effects of projective geometry. Hence, these still images cannot be simply “put together” or printed conveniently using the technologies commonly available for regular planar document such as faxes.

3. The still images of the full document or parts of it are subject to several optical effects and imaging degradations. The optical effects include: variable lighting conditions, shadowing, defocusing effects due to the optics of the imaging devices, fisheye distortions of the camera lenses. The imaging degradations are caused by image compression and pixel resolution. These optical effects and imaging degradations affect the final quality of the still images of the parts of the full document, making the documents virtually useless for many of the purposes documents typically serve.

4. In addition to all limitations applying to still images, video clips suffer from blocking artifacts, varying compression between frames, varying imaging conditions between frames, lower resolution, frame registration problems and a higher rate of erroneous image data due to communication errors.

The limited utility of the images/video clips of parts of the full document is manifest in the following:

1. These images of parts of the full document cannot be faxed because of a large dynamic range of imaging conditions within each image, and also between the images. For example, one of the partial images may appear considerably darker or brighter than the other because the first image was taken under different illumination than the second image. Furthermore, without considerable gray level reduction operations the images will not be suitable for faxing.

2. To read hand-printed writing in these images of parts of the full document even on a high quality computer screen, is very difficult, mainly due to dynamic range of the imaging device, imaging device resolution, compression artifacts, and color contrast of the text versus the background.

3. These images of parts of the full document cannot be stored and later retrieved in a uniform manner since several images of the same document may contain duplicities and some parts of the document may be missing from the complete image set.

In order to improve the utility of imaging devices as document capture tools, some existing systems provide extra processing on these images of a full document or parts of it. Some examples of such products are:

1. The RealEyes3D™ Phone2Fun™ product. This product is composed of software residing on the phone with the camera. This software enables conversion of a single image taken by the phone's camera into a special digitized image. In this digital image, the hand printed text and/or pictures/drawings are highlighted from the background to create more legible image which could potentially be faxed.

2. US Patent Application 20020186425, to Dufaux, Frederic, and Ulichney, Robert Alan, entitled “Camera-based document scanning system using multiple-pass mosaicking”, filed Jun. 1, 2001, describes a concept of taking a video file containing the results of a scan of a complete document, and converting it into a digitized and processed image which can be faxed or stored.

3. There are numerous other “panoramic stitching” products for digital cameras which supposedly enable the creation of a single large image from several smaller images with partial overlap. Examples of such products are Panorama™ from Picture Works Technology, Inc. and QuickStitch™ software from Enroute Imaging.

The image processing products outlined above suffer from certain fundamental limitations that make their widespread adoption problematic and doubtful. Among these limitations are:

1. It is hard to automatically differentiate between the text and the background without prior information. Therefore in some cases the resulting image is not legible and/or the background contains many details resulting from incorrect segmentation between background and text. A good example appears in FIG. 2. In FIG. 2, an image 201 is the original image, and an image 202 shows the effects of the prior art processing when attempting to convert such an image into a bitonal image suitable for sending via fax.

2. Since it is hard to automatically estimate the imaging angles of the document in a given image, the resulting processed document may contain geometric distortions altering the reading experience of the end-user.

3. The automatic registration of multiple images/frames with partial overlap is technically difficult. Traditional image registration (also known as “stitching” or “panorama generation”) methods assume that the images are taken at a large distance from the imaging apparatus, and that there are no significant projective or lighting variations between the different images to be stitched. These conditions are not fulfilled when document imaging is performed by a portable imaging device. In the typical use of a portable imaging device, the imaging distances are short, and therefore projective geometry and illumination variations between images (in particular due to the effect of the user and the portable device itself on illumination) are very prominent. Furthermore, there is no guarantee that the visual overlap between subsequent images will contain sufficient information to uniquely combine the images in the right way. For example, in FIG. 7, discussed further below, an example is provided of two images of parts of a document with no overlap, which could be mistaken to be overlapping images by prior art stitching software.

A different approach to document capture, sending and processing is based on dedicated non-imaging products that directly capture the user's entries into the document. Some examples of such devices are:

1. Personal Digital Assistants with touch-sensitive screens. Notable examples include the Palm family of PDAs, and the “Tablet PC” which is a complete personal computer with a touch-sensitive screen.

2. “E-pens”—devices where the precise location, speed and sometimes also pressure of the pen used for writing, are continuously monitored/measured using special hardware. Notable examples include the Anoto design implemented in the Logitech™, HP™ and Nokia™ E-pens, etc.

3. Pressure based and location based “tablets” that connect to a PC and provide tracking of a stylus, or of a normal pen, on a pre-defined area. A notable example is the pad used in many point-of-sale locations and by some delivery couriers to record the signature of the customer.

These non-imaging solutions require special hardware, require writing with or on special hardware, and introduce a different writing experience for the end-user.

### SUMMARY OF THE EXEMPLARY EMBODIMENTS OF THE INVENTION

An aspect of the exemplary embodiments of the present invention is to introduce a new and better way of converting displayed or printed documents into electronic ones that can be the read, printed, faxed, transmitted electronically, stored and further processed for specific purposes such as document verification, document archiving and document manipulation. Unlike prior art, where special purpose equipment is required, another aspect of the exemplary embodiments of the present invention is to utilize the imaging capability of a standard portable wireless device. Such portable devices, such as camera phones, camera enabled PDAs, and wireless webcams, are often already owned by users. By utilizing special recognition capabilities that exist today and some additional available information on the layout and contents of the imaged document, the exemplary embodiments of the present invention may allow documents of full one page (or larger) to be reliably scanned into a usable digital image.

According to an aspect of the exemplary embodiments of the present invention, a method for converting displayed or printed documents into an electronic form, is provided. The first stage of the method includes comparing the images obtained by the user to a database of reference documents. Throughout this document, the “reference electronic version of the document” shall refer to a digital image of a complete single page of the document. This reference digital image can be the original electronic source of the document as used for the document printing (e.g., a TIFF or Photoshop™ file as created by a graphics design house), or a photographic image of the document obtained using some imaging device (e.g., a JPEG image of the document obtained using a 3G video phone), or a scanned version of the document obtained via a scanning or faxing operation. This electronic version may have been obtained in advance and stored in the database, or it may have been provided by the user as a preparatory stage in the imaging process of this document and inserted into the same database. Thus, the method includes recognizing the document (or a part thereof) appearing in the image via visual image cues appearing in the image, and using a priori information about the document. This a priori information includes the overall layout of the document and the location and nature of image cues appearing in the document.

The second stage of the method involves performing dedicated image processing on various parts of the image based on knowledge of which document has been imaged and what type of information this document has in its various parts. The document may contain sections where handwritten or printed information is expected to be entered, or places for photos or stamps to be attached, or places for signatures or seals to be applied, etc. For example, areas of the image that are known to include handwritten input may undergo different processing than that of areas containing typed information. Additionally, the knowledge of the original color and reflectivity of the document can serve to correct the apparent illumination level and color of the imaged document. As an example, areas in the document known to be simple white background can serve for white reference correction of the whole document. As another example, areas of the document which have been scanned in separate images or video frames in different resolutions and from different angles can all be combined into one document of unified resolution, orientation and scale. Another example would be selective application of a dust or dirt removal operator to areas in the image known to contain plain background, so as to improve the overall document appearance.

The third stage of the method (which is optional) includes recognition of characters, marks or other symbols entered into the form—e.g. Optical mark recognition (OMR), Intelligent character recognition (ICR) and the decoding of machine readable codes (e.g. bar-codes).

The fourth stage of the method includes routing of the information based on the form type, the information entered into the form, the identity of the user sending the image and other similar data.

According to another aspect of the exemplary embodiments of the present invention, a system and a method for converting displayed or printed documents into an electronic form, is provided. The system and the method includes capturing an image of a printed form with printed or handwritten information filled in it, transmitting the image to a remote facility, pre-processing the image in order to optimize the recognition results, searching the image for image cues taken from an electronic version of this form which has been stored previously in the database, utilizing the existence and position of such image cues in the image in order to determine which form it is and the utilization of these recognition results in order to process the image into a higher quality electronic document which can be faxed, and the sending of this fax to a target device such as a fax machine or an email account or a document archiving system.

According to yet another aspect of the exemplary embodiments of the present invention, a system and a method may also present capturing several partial and potentially overlapping images of a printed document, transmitting the image to a remote facility, pre-processing the images in order to optimize the recognition results, searching each of the images for image cues taken from a reference electronic version of this document which has been stored in the database, utilizing the existence and position of such image cues in each image in order to determine which part of the document and which document is imaged in each such image, and the utilization of these recognition results and of the reference version in order to process the images into a single unified higher quality electronic document which can be faxed, and the sending of this fax to a target device.

Thus, part of the utility of the system is the enabling of a capture of several (potentially partial and potentially overlapping) images of the same single document, such that these images, by being of just a part of the whole document, each represent a higher resolution and/or superior image of some key part of this document (e.g. the signature box in a form). The resulting final processed and unified image of the document would thus have a higher resolution and higher quality in those key parts than could be obtained with the same capture device if an attempt was made to capture the full document in a single image. The prior art presented a dilemma between, on the one hand, limited resolution requiring costly special purpose high resolution imaging capture devices (such as flatbed scanners), or, on the other hand, acceptance of a single low quality image of the whole document as in the RealEyes™ product. A high resolution imaging may be provided without special purpose high resolution imaging capture devices.

Another part of the utility of the system is that if a higher resolution or otherwise superior reference version of a form exists in the database, it is possible to use this reference version to complete parts of the document which were not captured (or were captured at low quality) in the images obtained by the user. For example, it is possible to have the user take image close-ups of the parts of the form with handwritten information in them, and then to complete the rest of the form from the reference version in order to create a single high quality document.

Another part of the utility of the exemplary embodiments of the present invention is that by using information about the layout of a form (e.g., the location of boxes for handwriting/signatures, the location of checkboxes, the location places for attaching a photograph) it is possible to apply different enhancement operators to different locations. This may result in a more legible and useful document.

The exemplary embodiments of the present invention thus enable many new applications, including ones in document communication, document verification, and document processing and archiving.

### BRIEF DESCRIPTION OF THE DRAWINGS

Various other objects, features and attendant advantages of the exemplary embodiments of the present invention will become fully appreciated as the same become better understood when considered in conjunction with the accompanying detailed description, the appended claims, and the accompanying drawings, in which:

FIG. 1 illustrates a typical prior art system for document scanning.

FIG. 2 illustrates a typical result of document enhancement using prior art products that have no a priori information on the location of handwritten and printed text in the document.

FIG. 3 illustrates one exemplary embodiment of the overall method of the present invention.

FIG. 4 illustrates an exemplary embodiment of the processing flow of the present invention.

FIG. 5 illustrates an example of the process of document type recognition according to an exemplary embodiment of the present invention. FIG. 5A is an example of a document retrieved from a database of reference documents. FIG. 5B represents an imaged document which will be compared to the document retrieved from the database of reference documents.

FIG. 6 illustrates how an exemplary embodiment of the present invention may be used to create a single higher resolution document from a set of low resolution images obtained from a low resolution imaging device.

FIG. 7 illustrates the problem of determining the overlap and relative location from two partial images of a document, without any knowledge about the shape and form of the complete document. This problem is paramount in prior art systems that attempt to combine several partial images into a larger unified document.

FIG. 8 shows a sample case of the projective geometry correction applied to the images or parts of the images as part of the document processing according to an exemplary embodiment of the present invention.

FIG. 9 illustrates the different processing stages of an image segment containing printed or handwritten text on a uniform background and with some prior knowledge of the approximate size of the text according to an exemplary embodiment of the present invention.

### DETAILED DESCRIPTION OF THE EXEMPLARY EMBODIMENTS

An exemplary embodiment of the present invention presents a system and method for document imaging using portable imaging devices. The system is composed of the following main components:

1. A portable imaging device, such as a camera phone, a digital camera, a webcam, or a memory device with a camera. The device is capable of capturing digital images and/or video, and of transmitting or storing them for later transmission.

2. Client software running on the imaging device or on an attached communication module (e.g., a PC). This software enables the imaging and the sending of the multimedia files to a remote server. It can also perform part of or all of the required processing detailed in this application. This software can be embedded software which is part of the device, such as an email client, or an MMS client, or an H.324 or IMS video telephony client. Alternatively, the software can be downloaded software running on the imaging device's CPU.

3. A processing and routing computational facility which receives the images obtained by the portable imaging device and performs the processing and routing of the results to the recipients. This computational facility can be a remote server operated by a service provider, or a local PC connected to the imaging device, or even the local CPU of the imaging device itself.

4. A database of reference documents and meta-data. This database includes the reference images of the documents and further descriptive information about these documents, such as the location of special fields or areas on the document, the routing rules for this document (e.g., incoming sales forms should be faxed to +1-400-500-7000), and the preferred processing mode for this document (e.g., for ID cards the color should be retained in the processing, paper forms should be converted to grayscale).

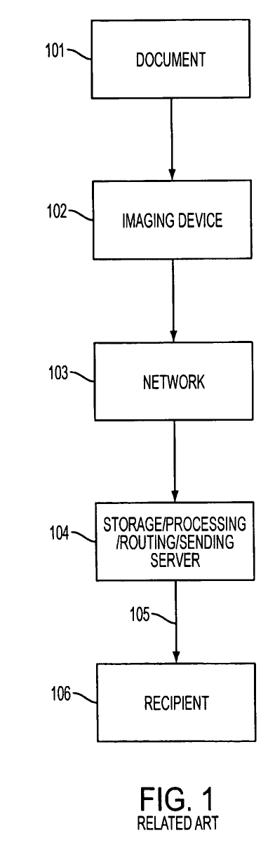

FIG. 1 illustrates a typical prior art system enabling the scanning of a document from single image and without additional information about the document. The document 101 is digitally imaged by the imaging device 102. Image processing then takes place in order to improve the legibility of the document. This processing may also include also data reduction in order to reduce the size of the document for storage and transmission—for example reduction of the original color image to a black and white “fax” like image. This processing may also include geometric correction to the document based on estimated angle and orientation extracted from some heuristic rules.

The scanned and potentially processed image is then sent through a wire-line/wireless network 103 to a server or combination of servers 104 that handle the storage and/or processing and /or routing and/or sending of the document. For example, the server may be a digital fax machine that can send the document as a fax over phone lines 105. The recipient 106 could for example be an email account, a fax machine, a mobile device, a storage facility.

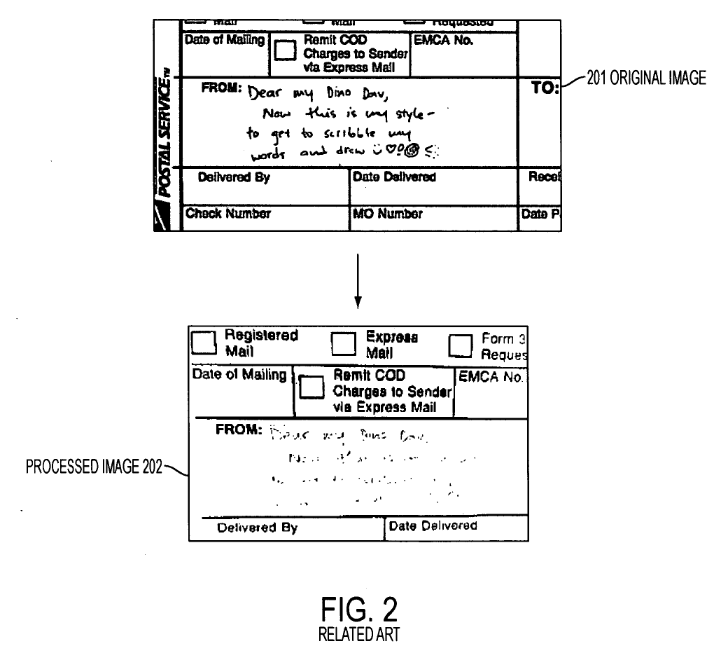

FIG. 2 displays typical limitations of prior art in text enhancement. A complex form containing both printed text in several sizes and fonts and handwritten text is processed. Since the algorithms of prior art do not have additional information about which parts of the image contain each type of text, they apply some average processing rule which causes the handwritten text, which is actually the most important part of the document, to become completely unreadable. Element 201 demonstrates that the original writing is legible, while element 202 shows that the processed image is unreadable.

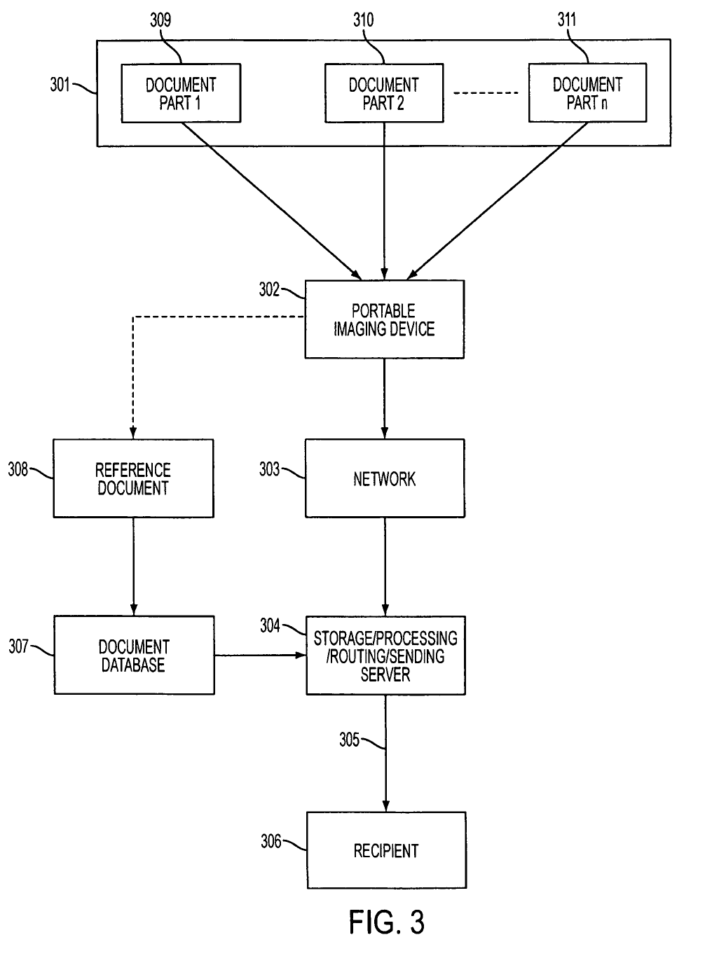

FIG. 3 illustrates one exemplary embodiment of the present invention. The input 301 is no longer necessarily a single image of the whole document, but rather can be a plurality of N images that cover various parts of the document. Those images are captured by the portable imaging device 302, and sent through the wire-line or wireless network 303 to a computational facility 304 (e.g., a server, or multiple servers) that handles the storage and/or processing and/or routing and/or sending of the document. The image(s) can be first captured and then sent using for example an email client, an MMS client or some other communication software. The images can also be captured during an interactive session of the user with the backend server as part of a video call. The processed document is then sent via a data link 305 to a recipient 306.

The document database 307 includes a database of possible documents that the system expects the user of 302 to image. These documents can be, for example, enterprise forms for filling (e.g., sales forms) by a mobile sales or operations employee, personal data forms for a private user, bank checks, enrollment forms, signatures, or examination forms. For each such document the database can contain any combination of the following database items:

1. Images of the document—which can be used to complete parts of the document which were not covered in the image set 301. Such images can be either a synthetic original or scanned or photographed versions of a printed document.

2. Image cues—special templates that represent some parts of the original document, and are used by the system to identify which document is actually imaged by the user and/or which part of the document is imaged by the user in each single image such as 309, 310, and 311.

3. Additional information about special fields or areas in the document, e.g. boxes for handwritten input, ticker boxes, places for a photo ID, pre-printed information, barcode location, etc. This information is used in the processing stage to optimize the resulting image quality by applying different processing to the different parts of the document.

4. Routing information—this information can include commands and rules for the system's business logic determining the routing and handling appropriate for each document type. For example, in an enterprise application it is possible that incoming “new customer” forms will be sent directly to the enrollment department via email, incoming equipment orders will be faxed to the logistics department fax machine, and incoming inventory list documents may be stored in the system archive. Routing information may also include information about which users may send such a form, and about how certain marks (e.g., check boxes) or printed information on the form (e.g. printed barcodes or alphanumeric information) may affect routing. For example, a printed barcode on the document may be interpreted to determine the storage folder for this document.

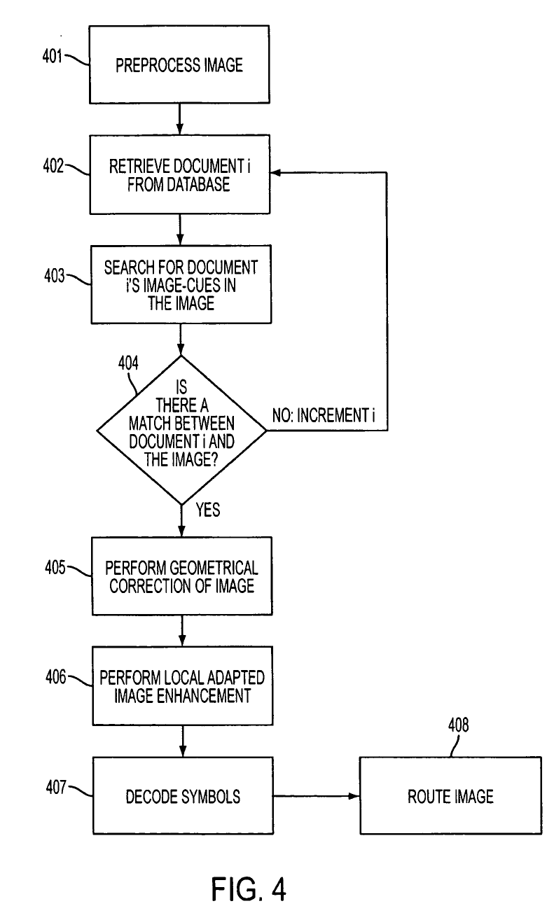

The reference document 308 is a single database entry containing the records listed above. The matching of a single specific document type and document reference 308 to the image set 301 is done by the computational facility 304 and is an image recognition operation. An exemplary embodiment of this operation is described with reference to FIG. 4.

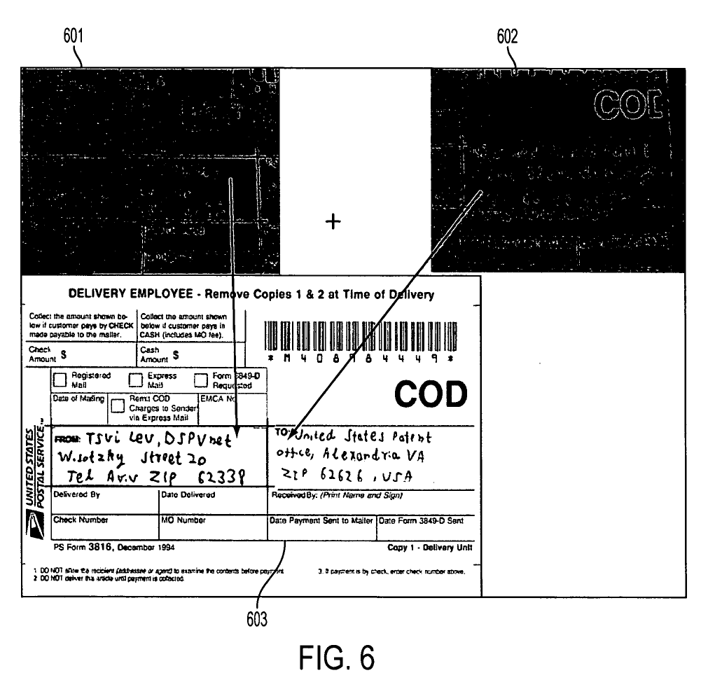

It is important to note that the reference document 308 may also be an image of the whole document obtained by the same device 302 used for obtaining the image data set 301. Hence the dotted line connecting 302 and 308, indicating that 308 may be obtained using 302 as part of the imaging session. For example, a user may start the document imaging operation for a new document by first taking an image of the whole document, potentially also adding manually information about this document, and then taking additional images of parts of the document with the same imaging device. This way, the first image of the whole document serves as the reference image, and the server 304 uses it to extract from it image cues and thus to determine for each image in the image set 301 what part of the full document it represents. A typical use of such a mode would be when imaging a new type of document with a low resolution imaging device. The first image then would serve to give the server 304 the layout of the document at low resolution, and the other images in image set 301 would be images of important parts of the document. This way, even a low resolution imaging device 302 could serve to create a high resolution image of a document by having the server 304 combine each image in the image set 301 into its respective place. An example of such a placement is depicted in FIG. 6.

Thus, the exemplary embodiment of the present invention is different from prior art in the utilization of images of a part of a document in order to improve the actual resolution of the important parts of the document. The exemplary embodiment of the present invention also differs from prior art in that it uses a reference image of the whole document in order to place the images of parts of the document in relation to each other. This is fundamentally different from prior art which relies on the overlap between such partial images in order to combine them. The exemplary embodiment of the present invention has the advantage of not requiring such overlap, and also of enabling the different images to be combined (301) to be radically different in size, illumination conditions etc. Thus the user of the imaging device 302 has much greater freedom in imaging angles and is freed from following any special order in taking the various images of parts of the document. This greater freedom simplifies the imaging process and makes the imaging process more convenient.

FIG. 4 illustrates the method of processing according to an exemplary embodiment of the present invention. Each image (of the multiple images as denoted in the previous figure as image set 301) is first pre-processed 401 to optimize the results of subsequent image recognition, enhancement, and decoding operations. The preprocessing can include operations for correcting unwanted effects of the imaging device and of the transmission medium. It can include lens distortions correction, sensor response correction, compression artifact removal and histogram stretching. At this pre-processing stage the server 304 did not determine yet which type of document is in the image, and hence the pre-processing does not utilize such knowledge.

The next stage of processing is to recognize which document or part thereof appears in the image. This is accomplished in the loop construct of elements 402, 403, and 404. Each reference document stored in the database is searched, retrieved, and compared to the image at hand. This comparison operation is a complex operation in itself, and relies upon the identification of image cues, which exist in the reference image, in the image being processed. The use of image cues, which represent small parts of the document, and their relative location, is especially useful in the present case for several reasons:

1. The imaged document may be a form in which certain fields are filled in with handwriting or typing. Thus, this imaged document is not really identical to the reference document, since it has additional information printed or handprinted or marked on it. Thus, a comparison operation has to take this into account and only compare areas where the imaged form would still be identical to the reference “empty” form.

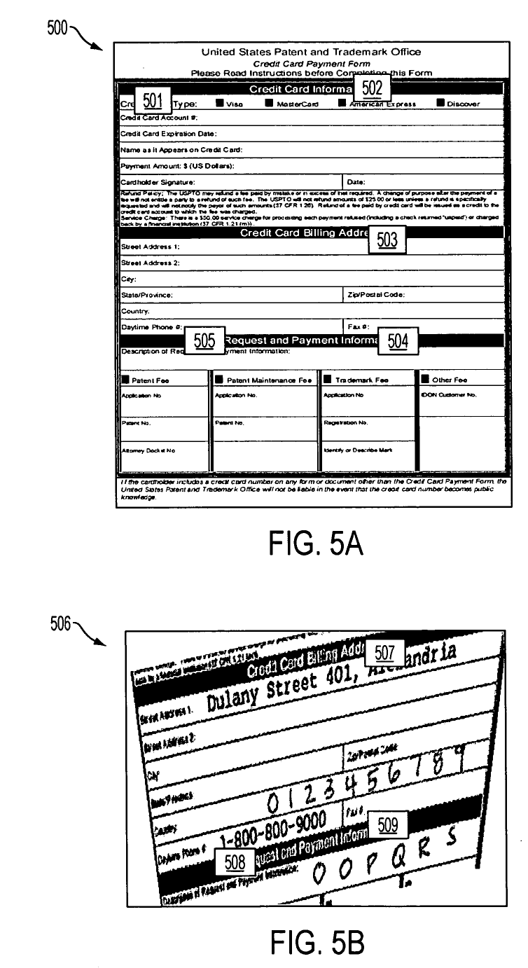

2. Since the image may be of a small part of the full reference document, a full comparison of the reference document to the image would not be meaningful. At the same time, image cues that exist in the reference document may still be located in the image even if the image is only of a segment of the full document. This ambiguity is illustrated in FIGS. 5A and 5B.

3. Due to the differences in scale, imaging angles, illumination variations and image degradations introduced by the limited resolution of the imaging sensor and image compression, the reliable comparison of a reference image of a document to an image obtained by a portable imaging device is in general a difficult endeavor. The utilization of image cues which are small in relation to the whole reference image is, according to an exemplary embodiment of the invention, a reliable and proven solution to this problem of image comparison.

The method used in the present embodiment to perform the search of the image cues in 403 and for determining the match in 404 is described in great detail in U.S. Non Provisional patent application Ser. No. 11/293,300, to the applicant herein Lev, Tsvi, entitled “SYSTEM AND METHOD OF GENERIC SYMBOL RECOGNITION AND USER AUTHENTICATION USING A CELLULAR/WIRELESS DEVICE WITH IMAGING CAPABILITIES”, filed on Dec. 5, 2005. The disclosure of such Application is hereby incorporated by reference in its entirety. This Application describes in great detail a possible method of reliably detecting image cues in digital images in order to recognize whether certain objects (including documents, as discussed herein) do indeed appear in those images.

There are many different variations of “image cues” that can serve for reliable matching of a processed image to a reference document from the database. Some examples are:

1. High contrast, preferably unique image patches from the reference document.

2. Special marks which have been inserted into the document on purpose to enable reliable recognition, such as, for example, “cross” signs at or near the boundaries of the document.

3. Areas of the document that are of a distinct color or texture or combination thereof—for example, blue lines on a black and white document.

4. Unique alphanumeric codes, graphics or machine readable codes printed on the document in a specific location or plurality of locations.

The determination of the location, size and nature of the image cues is to be performed manually or automatically by the server at the time of insertion of document insertion into the database.

A typical criterion for automatic selection of image cues would be a requirement the areas used as image cures are different from most of the rest of the document in shape, grayscale values, texture etc.

Assuming that the processed image has indeed been matched with a reference document or a part thereof, stage 405 then employs the knowledge about the reference document in order to geometrically correct the orientation, shape and size of the image so that they will correspond to a reference orientation, shape and size. This correction is performed by applying a transformation on the original image, aiming to create an image where the relative positions of the transformed image cue points are identical to their relative positions in the reference document. For example, where the only main distortion of the image is due to projective geometry effects (created by the imaging device's angles and distance from the document) a projective transformation would suffice. Or as another example, in cases where the imaging device's optics create effects such as fisheye distortion, such effects can also be corrected using a different transformation. The estimation of the parameters for these corrective transformations is derived from the relative positions of the image cues. Hence, the more image cues located in the image, the more precise the corrective transformation is. For example, in FIG. 5B an image is presented where only three image cues were located, hence it can be corrected using an affine transform but not by a full projective transform. Furthermore, typically the transform would not be applied to the original image but rather to an enlarged (and rescaled) version of the original image, in order to avoid or at least minimize the unwanted smoothing effects of image interpolation.

In stage 406, the image is already in the reference orientation and size, hence the metadata in the database about the location, size and type of different areas in the document can be used to selectively and optimally process the data in each such area. Some examples of such optimized processing are:

1. Replacing an area in the image with a clean reference version of it. In a form, there are typically many printed marks and fields which are part of the form and are not supposed to be influenced by the filling-out process of the form. Since the exact layout and content of the form itself are known in advance and stored in the database, it is possible to thus improve the overall legibility and utility of the resulting document. As a pertinent example, small font text typical of contractual forms and containing the exact terms and conditions of the deal signed may be hard to read from the image obtained by the user, yet the same exact text is stored in the database and can be used to fill in those hard-to-read parts of the document.

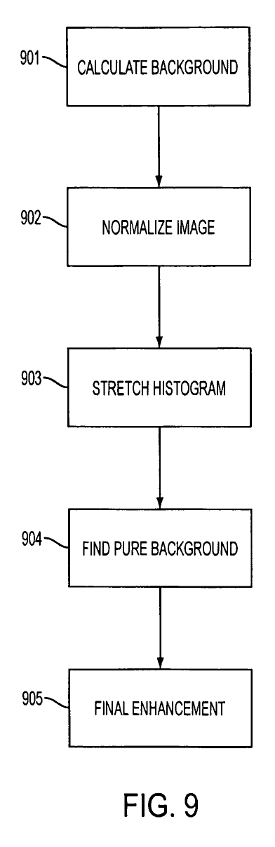

2. Scale optimized handwriting and printed text enhancement. In areas of a form which are to be filled in, the knowledge of the exact size and background (typically white) in this area, coupled with knowledge of the typical handwriting size or font size to be used in printed information, allow for better enhancement of the text in these areas. A typical subject of document processing research is the reliable differentiation between background and print in documents. In a general document, with no prior knowledge of whether a certain area contains a picture, text or graphics, this is indeed a very difficult problem. On the other hand, by using the information that the pixels in a certain segment of the image are composed of, for example, a white background and some text, this distinction between text and background becomes a much simpler problem that can be resolved with effective algorithms. A, exemplary technique for such enhancement is described below, in the text accompanying FIG. 9. It is important to note that most algorithms for enhancing the legibility and appearance of text rely to some extent on the text size and stroke width to be in some pre-determined range. Hence, a priori knowledge of the size of the text box and of the expected handwritten/printed text size is very useful for optimally applying such text enhancement algorithms. The use of such a priori knowledge in the exemplary embodiment of the current invention is an advantage over prior art systems that have no such a priori knowledge regarding the expected size of the text in the image.

3. Optimized adaptation taking into account both a priori knowledge of the image area and of the target device the document is to be routed to. For example, the form could include a photo of a person at some designated area, and the person's signature at another designated area. Thus, the processing of those respective areas can take into account both the expected input there (color photo, handwriting) and the target device—e.g., a bitonal fax, and thus different processing would be applied to the photo area and the signature area. At the same time, if the target device is an electronic archive system, the two areas could undergo the same processing since no color reduction is required.

In stage 407, optional symbol decoding takes place if this is specified in the document metadata. This symbol decoding relies on the fact that the document is now of a fixed geometry and scale identical to the reference document, hence the location of the symbols to be decoded is known. The symbol decoding could be any combination of existing symbol decoding methods, comprising:

1. Alphanumeric strings recognition and decoding—also known as Optical Character Recognition (OCR).

2. Recognition and decoding of known commercial symbols—also known as Optical Mark Recognition (OMR).

3. Machine code decoding—as in barcode or other machine codes.

4. Graphics Recognition—examples include the recognition of some sticker or stamp used in some part of the document—e.g. to verify the identity of the document.

5. Photo recognition—for example, facial ID could be applied to a photo of a person attached to the document in a specific place (as in passport request forms).

A sample algorithm for the decoding of alphanumeric codes and symbols is described in U.S. Non Provisional application Ser. No. 11/266,378, to the applicant herein Lev, Tsvi, entitled “SYSTEM AND METHOD OF ENABLING A CELLULAR/WIRELESS DEVICE WITH IMAGING CAPABILITIES TO DECODE PRINTED ALPHANUMERIC CHARACTERS”, filed Nov, 4, 2005. The disclosure of this Application is hereby incorporated by reference in its entirety.

In stage 408, the document, having undergone the previous processing steps, is routed to one or several destinations. The business rules of the routing process can take into considerations the following information pieces:

1. The identity of the portable imaging device and the identity of the user operating this imaging device, and additional information provided by the user along with the image.

2. The meta-data for the recognized document which can contain business logic rules specific to this document.

3. The results of the symbol decoding stage 407.

4. Indications about image quality such as image noise, focus, angle. Some indications such as imaging angle and imaging distance can be derived from the knowledge of the actual reference document size in comparison to the image being currently processed. For example, if the document is known to be 10 centimeters wide at some point, a measure of the same distance in the recognized image can yield the imaging distance of the camera at the time the image was taken.

Some specific examples of routing are:

1. The user imaging the document attaches to the message containing the image a phone number of a target fax machine. Thus, the processed image is converted to black and white and faxed to this target number.

2. The document in the image is recognized as the “incoming order” document. The meta-data for this document type specifies it should be sent as a high-priority email to a defined address as well as trigger an SMS to the sales department manager.

3. The document includes a printed digital signature in hexadecimal format. This signature is decoded into a digital string and the identity of the person who printed this signature is verified using a standard public-key-infrastructure (PKI) digital signature verification process. The result of the verification is that the document is sent to, and stored in, this person's personal storage folder.

It should be stressed that the different processing stages described in FIG. 4 can take place either after the user has sent the image(s) for processing (as in an off-line processing mode) or during the imaging session itself (as in on-line processing). On line processing is particularly useful when the user is in an interactive session with the server—e.g., in a videotelephony session or a SIP/IMS session. Examples of such interactivity include:

1. Adding the initial picture taken by the user of the whole document to the document database and using it during the session to correctly place further images taken by the user into their respective positions.

2. Informing the user that he or she forgot to take images of some important parts of the document (such as, for example, a signature field).

3. Guiding the user to the proper areas and proper imaging distance in order to optimally capture some parts of the document (for example, “move camera to the right and closer please”), based on the recognition of the part of the document the camera is currently pointing at and the image cue location.

4. Notifying the user if the images obtained so far are of sufficient illumination and sharpness, or if they should be re-captured.

5. Giving further instructions to the user based on the results of the OCR/OMR/symbol recognition. For example, if the form is recognized to contain a serial number that is known to be no longer valid, the user could be warned of this and instructed to use a newer form at the time of document capture.

FIGS. 5A and 5B illustrate a sample process of recognition of a specific image. A certain document 500 is retrieved from the database. It contains several image cues 501, 502, 503, 504 and 505, which are searched for in the obtained image 506. A few of them are found and in the proper geometric relation. A sample search and comparison algorithm for the image cues is described in U.S. Non Provisional application Ser. No. 11/293,300, cited above and incorporated in its entirety. The occurrence of the image cues in 503, 504, and 505 in the image, in areas 507, 508, and 509, thus serve to recognize which part of which document the image 506 contains. It is important to note that the same process could be applied when the image has been itself obtained by the user as e.g. the first image in the sequence. In such a case, the recognition for image 506 would be relevant for locating the part of original image 500 which appears in it, but there would not be any “metadata” in the database unless the user has specifically provided it. It should be noted that the image cues can be based on color and texture information—for example, a document in specific color may contain segments of a different color that have been added to it or were originally a part of it. Such segments can serve as very effective image cues.

FIG. 6 illustrates how the exemplary embodiment of the present invention can be used to create a single high resolution and highly legible image from several lower quality images of parts of the document. Images 601 and 602 were taken by a typical portable imaging device. They can represent photos taken by a camera phone separately, photos taken as part of a multi-snapshot mode in such a camera phone or digital camera, or frames from a video clip or video transmission generated by a camera phone. These images have been recognized by the system as parts of a reference document entitled “US Postal Service Form #1”, and accordingly the images have been corrected and enhanced. Only the parts of these images that contain handwritten input have been used, and the original reference document has been used to fill in the rest of the resulting document 603. It can be clearly seen that the original images suffered from some fisheye distortion, bad contrast, graininess and non-uniform lighting, but due to the correction and enhancement applied, the resulting final document 603 is free from all of these effects. The system can thus also be applied to signatures in particular, optimally processing the image of a human signature, and potentially comparing it to an existing database of signatures for verification or comparison purposes.

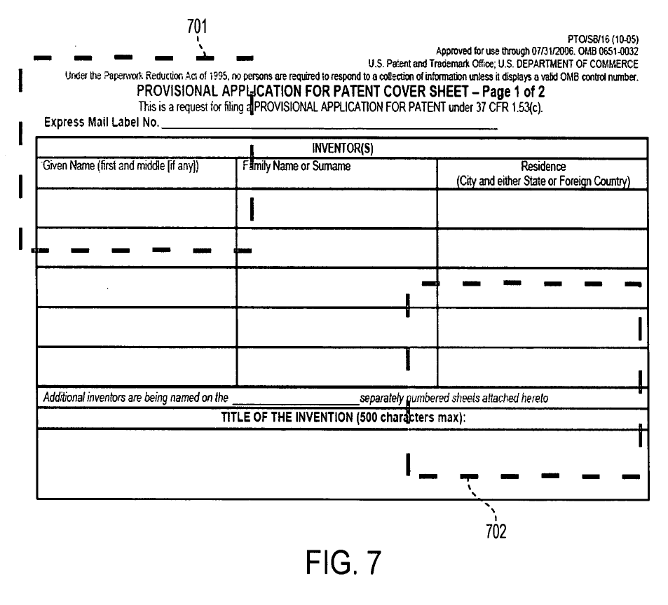

FIG. 7 illustrates the deficiencies of prior art. Images 701 and 702 have been sent via the imaging device, and cover different and non-overlapping areas of the document. However, the upper left part of image 701 is virtually identical to the lower right part of image 702. Hence, any image matching algorithm which works by comparing images and combining them would assume, incorrectly in this case, that these images should be combined. (An exemplary embodiment of the present invention, conversely, locates images 701 and 702 in the larger framework of the reference image of the whole document, and would therefore not make such a mistake, but would place all images in their correct position, as described further below). Furthermore, the requirement of prior art to maintain substantial overlap between consecutive images in a sequence implies that only specific “scanning” movements are allowed, and that the user's imaging angles, speed of movement of the mobile device, and distance from the document are severely constrained, resulting in a lengthy and inconvenient process. Furthermore, the user is forced to image the whole document for correct registration, even if the important information contained in the document is concentrated in just a few small areas of the document (e.g. the signature at the bottom of the document).

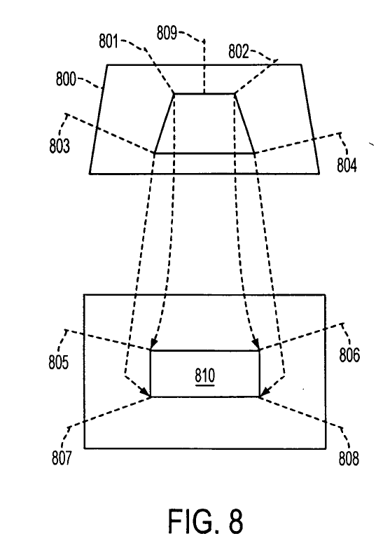

FIG. 8 illustrates how a segment of the image is geometrically corrected once the image 800 has been correlated with the proper reference document. The area 809, bounded by points 801, 802, 803, and 804, is identified using the metadata of the reference document as a “text box”, and is geometrically corrected using for example a projective transformation to be of the same size and orientation as the reference text box 810 bounded by points 805, 806, 807, and 808. The utilization of the image cues provides the correspondence points which are necessary to calculate the parameters of the projective transformation.

FIG. 9 illustrates the different processing stages of an image segment containing printed or handwritten text on a uniform background and with some prior knowledge about the approximate size of the text. This algorithm represents one of the processing stages that can be applied in 406.

In order to correct for lighting non-uniformities in the image, the illumination level in the image is estimated from the image at 901. This is done by calculating the image grayscale statistics in the local neighborhood of each pixel, and using some estimator on that neighborhood. For example, in the case of dark text on lighter background, this estimator could be the nth percentile of pixels in the M by M neighborhood of each pixel. Since the printed text does not occupy more than a few percents of the image, estimators such as the 90^{th} percentile of gray scale values would not be affected by it and would represent a reliable estimate of the background grayscale which represents the local illumination level. The neighborhood size M would be a function of the expected size of the text and should be considerably larger than the expected size of a single letter of that text.

Once the local illumination level has been estimated, the image can be normalized to eliminate the lighting non uniformities in 902. This can be accomplished by dividing the value of each pixel by the estimated illumination level in the pixel's neighborhood as estimated in the previous stage 901.

In 903, histogram stretching is applied to the illumination corrected image obtained in 902. This stretching enhances the contrast between the text and the background, and thereby also enhances the legibility of the text. Such stretching could not be applied before the illumination correction stage since in the original image the grayscale values of the text pixels and background pixels could be overlapping.

In stage 904, the system again utilizes the knowledge that the handprinted or printed text in the image is known to be in a certain range of size in pixels. Each image block is examined to determine how many pixels it contains whose grayscale value is in the range of values associated text pixels. If this number is below a certain threshold, the image block is declared as pure background and all the pixels in that block are set to some default background pixel value. The purpose of this stage is to eliminate small marks in the document which could be caused by dirt, pixel nonuniformity in the imaging sensor, compression artifacts and similar image degrading effects.

It is important to note that the processing stages described in 901, 902, 903, and 904, are composed of image processing operations which may be used, in different combinations, in related art techniques of document processing. In an exemplary, non-limiting embodiment of the present invention, however, these operations utilize the additional knowledge about the document type and layout, and incorporate that knowledge into the parameters that control the different image processing operations. The thresholds, neighborhood size, spectral band used and similar parameters can be all optimized to the expected text size and type, and the expected background.

In stage 905 the image is processed once again in order to optimize it to the routing destination(s). For example, if the image is to be faxed it can be converted to a bitonal image. If the image is to be archived, it can be converted into grayscale and to the desired file format such as JPEG or TIFF. It is also possible that the image format selected will reflect the type of the document as recognized in 404. For example, if the document is known to contain photos, JPEG compression may be better than TIFF. If the document on the other hand is known to contain monochromatic text, then a grayscale or bitonal format such as bitonal TIFF could be used in order to save storage space.

Other variations and modifications are possible, given the above description. All variations and modifications which are obvious to those skilled in the art to which the present invention pertains are considered to be within the scope of the protection granted by this letter patent.

What is claimed is:

1. A method for imaging a document, and using a reference document to place pieces of the document in their correct relative position and resize such pieces in order to generate a single unified image, the method comprising:
electronically capturing a document with one or multiple images using an imaging device;
performing pre-processing of said images to optimize the results of subsequent image recognition, enhancement, and decoding;
comparing said images against a database of reference documents to determine the most closely fitting reference document; and
applying knowledge from said closely fitting reference document to adjust geometrically orientation, shape, and size of said electronically captured images so that said images correspond as closely as possibly to said reference document.

2. The method of claim 1, wherein the method further comprises:
after completion of processing, routing the document to one or a multiplicity of electronic or physical locations.

3. The method of claim 1, wherein the method further comprises:
applying metadata from said database of reference documents to selectively and optimally process the data from each area of said document as such area has been identified by said geometric adjustment of said captured electronic images.

4. The method of claim 3, wherein the method further comprises:
after completion of processing, routing the document to at least one of electronic and physical locations.

5. The method of claim 3, wherein the method further comprises:
applying an optical recognition technique decoding information on said imaged document by comparison to known optical symbols.

6. The method of claim 5, wherein:
said optical recognition technique is Optical Character Recognition.

7. The method of claim 5, wherein:
said optical recognition technique is Optical Mark Recognition.

8. The method of claim 6, wherein the method further comprises:
after completion of processing, routing the document to at least one of electronic and physical locations.

9. The method of claim 7, where in the method further comprises:
after completion of processing, routing the document to at least one of electronic and physical locations.

10. The method of claim 1, wherein the method further comprises:
identification of symbols within said document by said comparison of said images and said geometric adjustment of said images; and
decoding of said symbols.

11. The method of claim 8, wherein the imaging device captures photographic images of the document.

12. The method of claim 8, wherein the imaging device captures video images of the document.

13. The method of claim 9, wherein the imaging device captures video photographic images of the document.

14. The method of claim 10, wherein the imaging device captures video images of the document.

15. The method of claim 1, wherein:
said imaging device captures at least two images of said document;
said at least two images are of at least two different parts of the document;
said at least two images are recognized as processed so that they are recognized as said at least two different parts of a reference document; and
based on said recognition, forming a unified image of a higher photographic quality than at least one of said at least two images.

16. A system for imaging a document, and using a reference document to place pieces of the document in their correct relative position and resize such pieces in order to generate a single unified image, the system comprising:
at least one document to be electronically captured;
a portable imaging device for electronically capturing said document with at least one image;
a network for pre-processing said at least one image to optimize the results of subsequent image recognition, enhancement, and decoding;
a database comprising reference documents for comparing against said at least one pre-processed image; and
at least one server for receiving said at least one pre-processed image from the network, storing said at least one image, performing final processing, comparing said at least one image against at least one reference document, and routing the processed images to one or more recipients.

17. The system of claim 16, wherein:
said imaging device captures at least two images of said document;
said at least two images are of at least two different parts of the document;
said at least two images are recognized as processed so that they are recognized as two different parts of a reference document; and
based on a result of said recognition, forming a unified image of a higher photographic quality than at least one of said at least two images.

18. The system of claim 16, wherein:
said portable imaging device is configured to electronically capture at least one of photographic images and video clips of said document.

19. The system of claim 16, wherein:
said portable imaging device is configured to electronically capture photographic images of said document, and cannot electronically capture video clips of said document.

20. A computer program product stored on a computer readable medium for causing a computer medium to perform a method comprising:
electronically capturing a document with at least one image using an imaging device;
performing pre-processing of said at least one image to optimize results of subsequent image recognition, enhancement, and decoding;
comparing said at least one image against reference documents stored in a database, to determine most closely fitting reference document;
applying knowledge from said closely fitting reference document to adjust geometrically orientation, shape, and size of said electronically captured images so that said at least one image corresponds as closely as possibly to said reference document.
